(19) United States
(12) Patent Application Publication
(10) Pub. No.: US 2019/0182248 A1
(43) Pub. Date: Jun. 13, 2019

(54) PASSWORDLESS ELECTRONIC MAIL (E-MAIL) COMMUNICATION METHOD AND SYSTEM

(71) Applicant: Mitthan L. Meena, Fremont, CA (US)

(72) Inventor: Mitthan L. Meena, Fremont, CA (US)

(21) Appl. No.: 16/281,114

(22) Filed: Feb. 21, 2019

(51) Int. Cl. H04L 29/06; H04L 12/58

(52) U.S. Cl. CPC H04L 63/0876; H04L 63/0838; H04L 51/046; H04L 51/38; H04L 63/0815

(57) ABSTRACT

Disclosed is a passwordless electronic mail (e-mail) communication method and system. The method includes receiving a cell phone number inputted by a user over a user communication device for registering the user with a server hosting a passwordless email service website with a domain name, sending a SMS message including a verification code to the user using Hypertext Preprocessor (PHP) APIs, authenticating the user communication device using the received verification code, and in response to a successful authentication of the user communication device of the user: converting the received cell phone number into a predefined text email address containing the cell phone number and the domain name, and facilitating the user with transmission and reception of e-mails globally, to and from another user using the converted predefined text email address.

### FIELD OF THE INVENTION

The present invention relates to the field of communications system and method, and, more particularly, to a passwordless electronic mail (e-mail) communications system and related method.

### BACKGROUND

Currently, systems and methods exist that allow a user to send Short Message Service (SMS) messages or electronic mails (e-mails) to another user from a user related communication device such as a mobile phone. Technically, the SMS messages can be initiated by the user using any user related communication device that has phone capabilities and the phone company then charges the user a fee for a text message that the user sends to the another user using the phone company's gateway. The problem is, although the per message charge from the phone company is relatively small for such SMS messages, it can become very expensive if the user has to send lot of text messages to number of users. Besides this, the user has to remember the phone numbers of recipients of such SMS messages.

With the development of Internet, e-mail has been widely used and has become an integral part of business and personal communications. As such, many users have multiple email accounts for work and home use. Moreover, with the increased availability of cellular phones and wireless local area network (LAN) devices that can send and receive emails, many users wirelessly access e-mails stored in source mailboxes of different email storage servers (e.g., Gmail, Yahoo, Hotmail, AOL, etc.) which offer free account creation and e-mail services. Almost all of the e-mail users are provided with at least one e-mail account (or e-mail address) by such email servers which the e-mail users can use for sending and receiving messages to and from other e-mail users.

Typically, in such e-mail communications system, a sender is required to know at least one e-mail address of a recipient and also needs to keep himself/herself updated about a new e-mail address when the recipient's address is changed in order to communicate with the recipient. Such change in the e-mail address of the recipient necessarily require additional efforts from the sender towards needing to know or remember the new e-mail address of the recipient in order for the sender to be able to send any email messages to the recipient. It is quite difficult in this fast moving world, for any users to keep track of e-mail address changes. Further, in such e-mail communications system, the sender is often required to login to his/her account over his/her communication device in order to be able to communicate with the recipient. Typically, the sender uses his/her login credentials (preferably a password) to login to his/her email account and thus has to remember such login credentials. Further, many of such existing e-mail communications system do not authenticate the communication device associated with the sender each time the sender change his/her communication device.

Accordingly, there remains a need in the art for an improved system and method to allow an e-mail user (i.e., an e-mail sender) to send an email to a recipient even if the e-mail sender does not know the recipient's e-mail address.

### BRIEF SUMMARY

It is an objective of the present invention to provide a system and method for a passwordless electronic mail (e-mail) communication between users (sender and recipients of the emails).

Another objective of the present invention is to provide a passwordless e-mail communications system and method that makes use of a user cell phone number to create a user account, and generate a predefined text email address using the user provided cell phone number, and a domain name of website hosted on a passwordless e-mail service providing server Eg. <user provided cell phone number>@<domain name>, or <country code><user provided cell phone number>@<domain name>.

Another objective of the present invention is to provide a passwordless e-mail communications system and method is to enable the user to send and receive emails globally to and from another user using the predefined text email address associated with the user.

Yet another objective of the present invention is to provide the passwordless e-mail communications system and method that make use of an identity of the user communication device to allow the user to auto login on an e-mail client installed on the user communication device associated therewith.

Yet another objective of the present invention is to provide the passwordless e-mail communications system and method that enables a user registered with the system to communicate with another user who is registered or unregistered with the system.

Yet another objective of the present invention is to provide the passwordless e-mail communications system and method that enables a user registered with the system to communicate with 1000s of contact numbers (that might be in his/her phone book) without requiring or needing to know any email addresses of those contacts. The user can just click on the selected contact name in the phonebook to send any email messages to the selected contact.

Embodiments of the present invention provides a passwordless electronic mail (e-mail) communication method and system. The passwordless email communication method includes receiving, by the first server, data inputted over an e-mail client installed on a user communication device of a first user for registering the first user with a first server hosting a passwordless email service website with a domain name, wherein the data for registering the user communication device of the first user with the first server comprising at least one of: a cell phone number, and a country code, sending, by the first server, a Short Message Service(SMS) message comprising a verification code to the user communication device of the first user using Hypertext Preprocessor (PHP) APIs, authenticating, by the first user, the user communication device using the received verification code; and, in response to a successful authentication of the user communication device of the first user: converting, by the first server, at least one of: the cell phone number, and the country code of the first user into a predefined text email address comprising the cell phone number and the domain name, and facilitating the first user with transmission and reception of e-mails globally, to and from a second user using the predefined text email address.

These and other objects of the present invention will become readily apparent upon further review of the following specification and drawings.

### BRIEF DESCRIPTION OF THE DRAWINGS

For a better understanding of the aforementioned objectives, aspects and embodiments of the present invention, as well as additional aspects and embodiments thereof, reference should be made to the description of embodiments provided below, in conjunction with the following drawings in which like reference numerals refer to corresponding parts throughout the figures.

FIGS. 1A-1B are block diagrams that illustrate system environments in which various embodiments of the present invention are practiced.

FIG. 2 is a block diagram illustrating functional blocks facilitating operations a passwordless e-mail service providing server, according to an exemplary embodiment.

FIG. 3 is a general block diagram for a system architecture of a computer system implemented as the passwordless e-mail service providing server that facilitates a passwordless e-mail communication between users, in accordance with an embodiment of the present invention.

FIGS. 4-5 illustrate a method for the passwordless e-mail communication between the users, in accordance with an embodiment of the present invention.

FIGS. 6-13 illustrates various examples of graphical user interfaces (GUIs) displayed to the user over the user communication device associated therewith that facilitates implementation of the method or a portion of method illustrated in the FIGS. 4-5.

### DETAILED DESCRIPTION

As used in the specification, the singular forms “a”, “an” and “the” may also include plural references. For example, the term “a user”, “a user communication device) may include a plurality of users and user communication devices. Those with ordinary skill in the art will appreciate that the elements in the accompanying figures are illustrated for simplicity and clarity and are not necessarily drawn to scale. There may be additional components described in the foregoing application that may not be depicted on the described drawings. In the event such a component is described, but not depicted in a drawing, the absence of such components from the drawing should not be considered as an omission of such design from the specification.

Before describing the present invention in detail, it should be observed that the present invention utilizes a combination of components, which constitutes methods and systems for a passwordless email communication between various users. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting but rather to provide an understandable description of the invention. For the purpose of this invention, the terms “user”, “sender”, “first user” and so on are interchangeably used in the following description. Likewise, the terms “user”, “recipient”, “second user” and so on are interchangeably used in the following description

References to “one embodiment”, “an embodiment”, “another embodiment”, “one example”, “an example”, “another example”, “an aspect”, “another aspect” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Further, the words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” and so on used in this description are used to arbitrarily distinguish between the elements. Thus, these terms are not necessarily intended to indicate temporal or other prioritization of such elements.

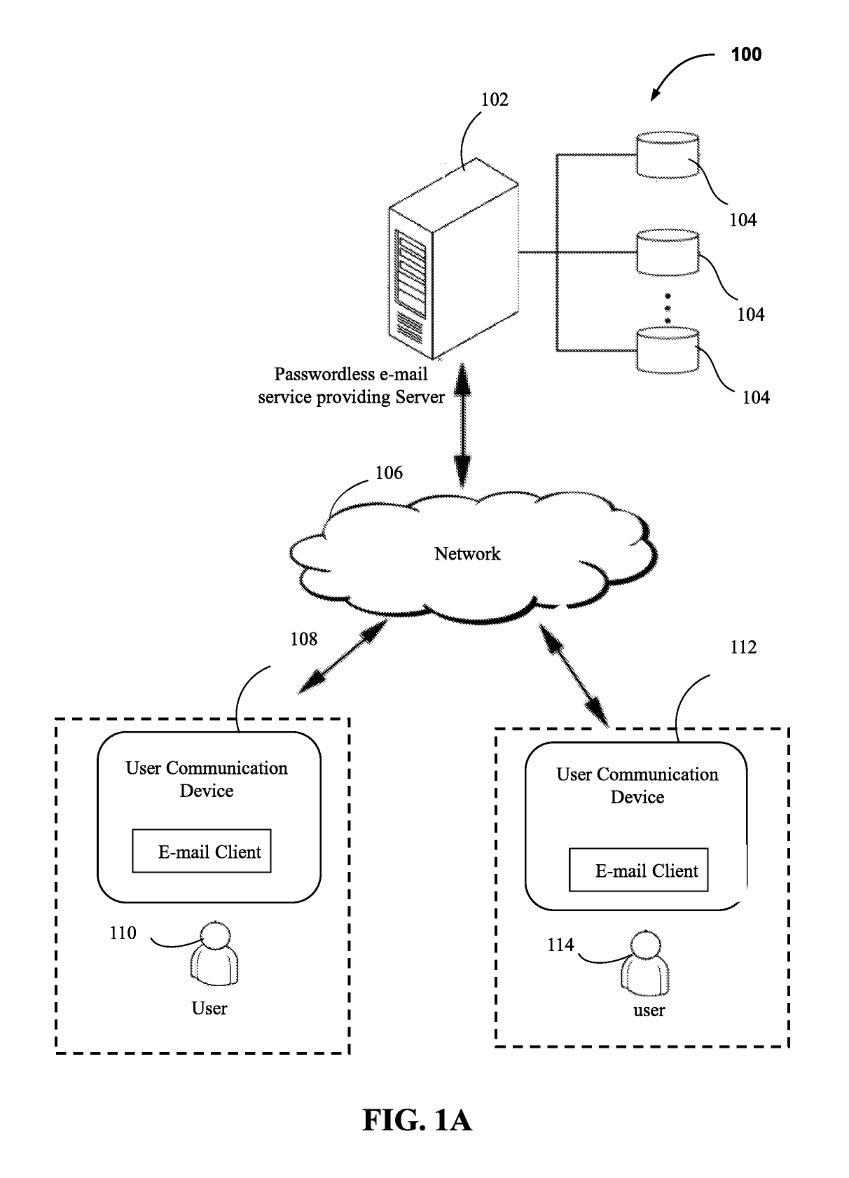

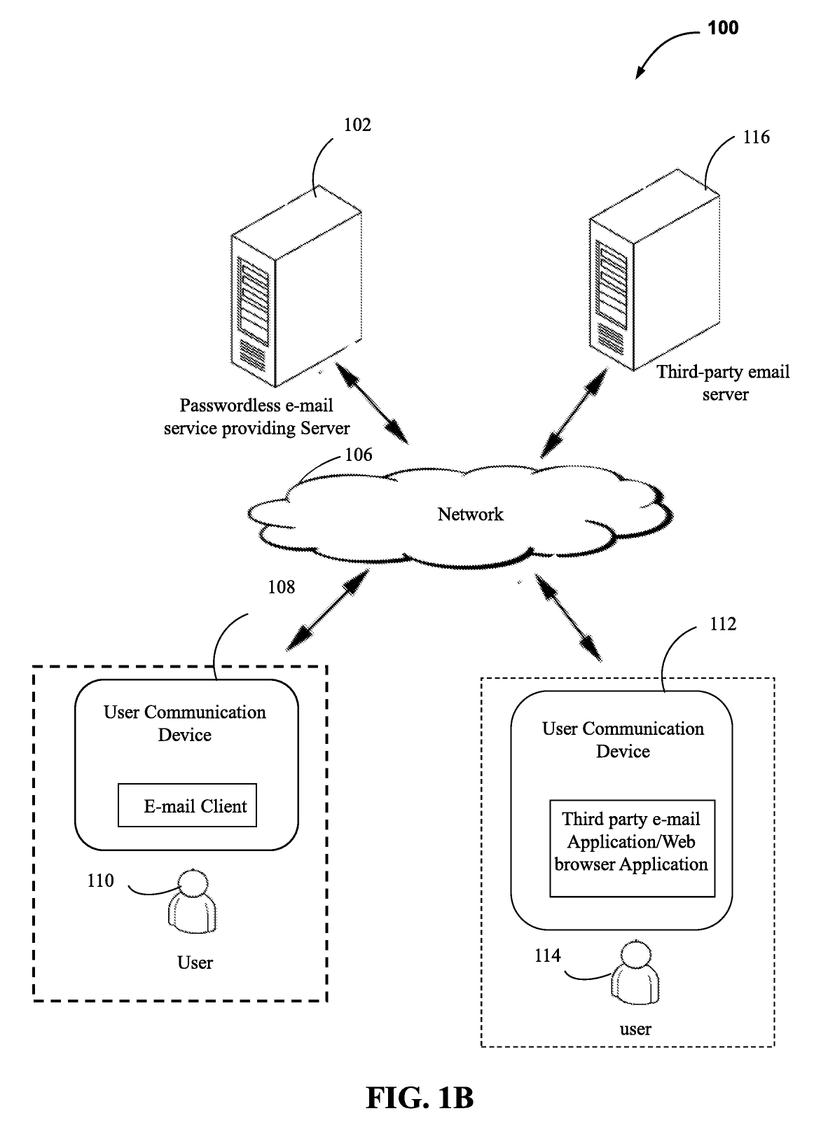

Various embodiments of the present invention will now be described with reference to FIGS. 1-13. Referring to the FIGS. 1A-1B, system environments 100 are shown that facilitate a sender/user to perform a passwordless electronic mail (e-mail) communication to and from another user or recipient.

The system environment 100 includes a passwordless email service providing server 102 (referred to as “server” hereafter), one or more database servers such as a database server 104, and a network 106. The system environment 100 further includes a user communication device 108 associated with the user/sender 110, and a user communication device 112 associated with the user/recipient 114. The user communication devices 108,112 may include but not limited to mobile phones and the like devices. The server 102, the user communication device 108, and the user communication device 112 may communicate with each other over a communication network such as the network 106. The server 102, and the database server 104 may also communicate with each other over the same network 106 or over a different network.

The server 102 is a computer, a software framework, or a combination thereof, that may provide a generalized approach to create the application server implementation for realizing the present invention. The server 102 of the present invention is configured to host a passwordless email service website owned by an email service provider such as for example: “www.passwordlessemailservice.com” with a domain name as “passwordlessemailservice.com”. Further, the server 102 is configured to make available an email client to users 110,114 (via the network 106) registered with it, so that the users 110,114 can access the services of the server 102 over the email client installed on the communication devices 108,112 associated therewith.

Although the present disclosure is explained by considering that the system 100 is implemented on the server 102, it may be understood that the system 100 may also be implemented in a variety of computing systems, such as a mainframe computer, a network server, cloud, and the like. The server 102 may be realized through various web-based technologies such as, but not limited to, a Java web-framework, a .NET framework, a PHP (Hypertext Preprocessor) framework, or any other web-application framework. The server 102 may be configured to operate on one or more operating systems such as Windows, Android, Unix, Ubuntu, Mac OS, or the like.

The server 102 typically include at least one processor, an input/output (I/O) interface, and a memory. The processor may be implemented as one or more microprocessors, microcomputers, microcontrollers, digital signal processors, central processing units, state machines, logic circuitries, and/or any devices that manipulate signals based on operational instructions. Among other capabilities, the processor is configured to fetch and execute computer-readable instructions or program instructions stored in the memory (any computer-readable medium known in the art). Preferably, one or more set of instructions/programs that defines the functions of the server 102 would be stored in the memory which will then be executed by the processor to make the functionality of the server 102 realizable.

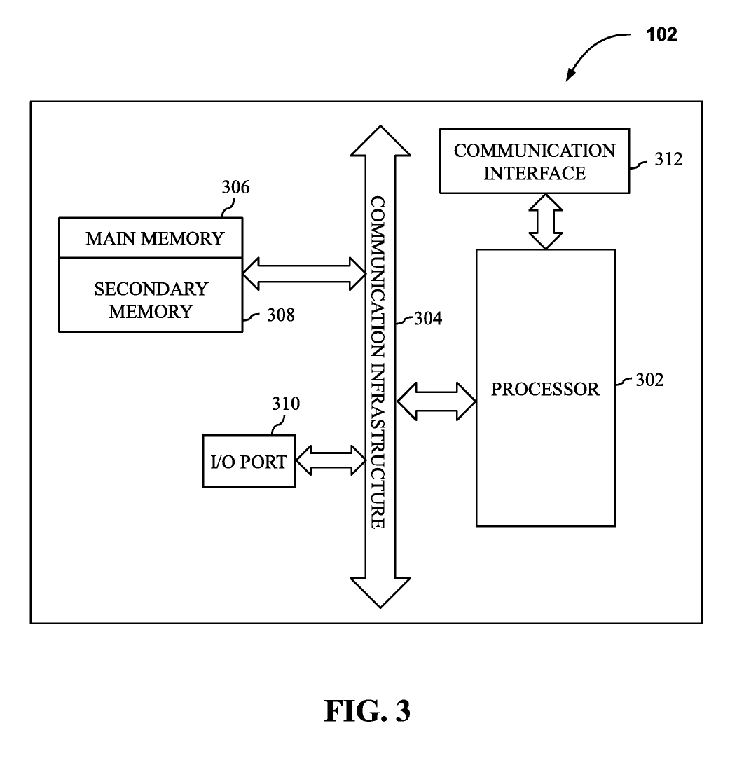

The server 102 may further include an I/O interface comprising a variety of software and hardware interfaces, for example, a web interface, a graphical user interface, and the like. The I/O interface may allow the server 102 to interact with the users 110, 114 through the user communication devices 108 or 112 associated with the user 110 and the user 114 respectively. Further, the I/O interface may enable the server 102 to communicate with other communication devices, such as web servers and external data servers such as external third-party email servers 116. The I/O interface may further facilitate multiple communications within a wide variety of networks and protocol types, including wired networks, for example, LAN, cable, etc., and wireless networks, such as WLAN, cellular, or satellite. In one embodiment of the invention, the users 110, 114 may access the server 102 and associated functionality in the form of one or more user interfaces and perform various operations using the email client installed over the user communication devices 108, 112, enabled via the I/O interface and various communication interfaces. The system architecture or implementation for the server 102 is very briefly described here, the same would be described in more detailed with respect to the FIG. 3 in the description to follow.

The database or database server 104 may include suitable logic, circuitry, interfaces, and/or code, executable by the circuitry that may be configured to perform one or more data management and storage operations such as receiving, storing, processing, and transmitting queries, data, or content. In an embodiment, the database server 104 may be a data management and storage computing device that may be communicatively coupled to the server 102, the user communication device 108, or the user communication device 112 via the network 106 to perform the one or more operations. In an exemplary embodiment, the database server 104 may be configured to manage and store data related to the users 110,114, for example, profile information related to the users 110, 114, cell phone numbers associated with the users 110, 114, store incoming email messages from the users 110, 114, store identity associated with the user communication devices 108,112, events and tasks created by the users 110, 114 and so on.

In an embodiment, the database server 104 may be configured to receive a query from the server 102 for retrieval of the stored information, For example, query on retrieval of an identity of the communication device 108 of the user 110 to help the user auto login onto the email client installed thereon. Based on the received query, the database server 104 may be configured to communicate the requested information to the server 102. Examples of the database server 104 may include, but are not limited to, a personal computer, a laptop, or a network of computer systems.

The network 106 may include suitable logic, circuitry, interfaces, and/or code, executable by the circuitry that may be configured to transmit SMS messages, emails and requests between various entities, such as the server 102, the server 116, the database server 104, the user communication device 108, and the user communication device 112. Examples of the network 106 include, but are not limited to, a wireless fidelity (Wi-Fi) network, a local area network (LAN), a wide area network (WAN), a metropolitan area network (MAN), a satellite network, the Internet, a fiber optic network, a coaxial cable network, an infrared (IR) network, a radio frequency (RF) network, cellular phone link for the mobile phone users to send and receive SMS messages and combinations thereof. Various entities in the system environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

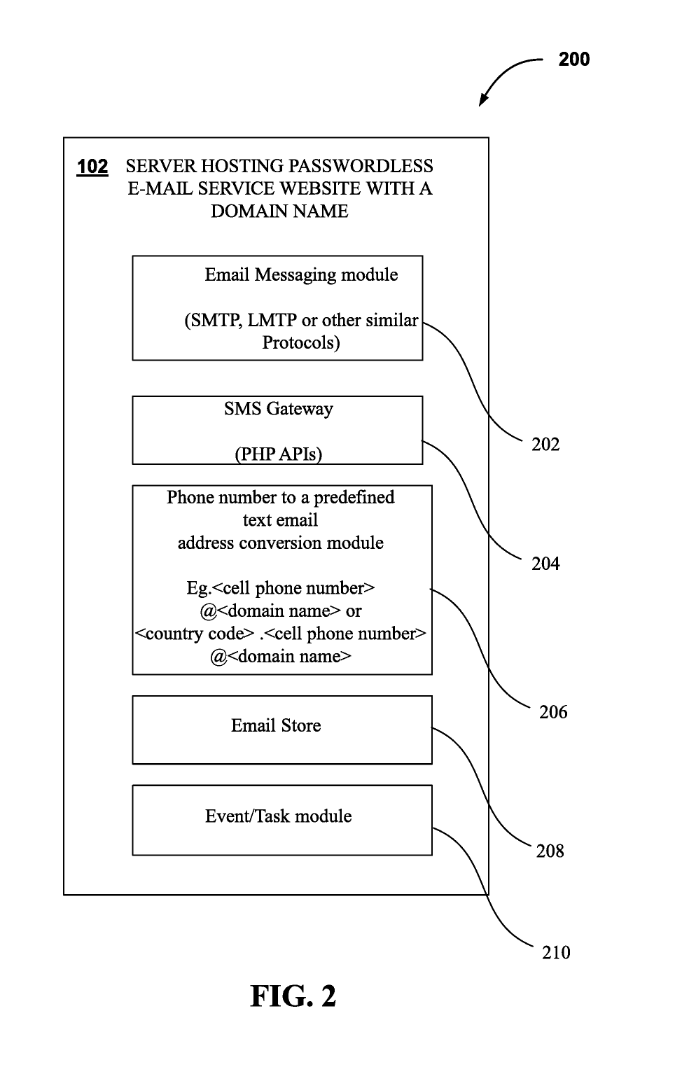

The server 102 of the present invention includes one or more functional modules that facilitate the user/sender 110 to send and receive email messages globally to and from the user/recipient 114 using a special text email address that's formed by using the cell phone of the user 110 and the domain name of the passwordless email service website hosted on the server 102. Referring to the FIG. 2, the one or more functional modules may include an email messaging module 202, a SMS gateway 204, a phone number to a predefined text email address conversion module 206, an email store 208, and an event and task module 210.

The email messaging module 202 is configured to receive an email message from the sender 110 and direct the email to the recipient 114 if both the sender 110 and the recipient 114 are registered with the server 102. If the recipient 114 is found to be non-registered with the server 102, then the email messaging module 202 may direct the incoming email message from the user 110 via a third party email server 116 with which the recipient might be registered in order to deliver the email to the intended recipient 114. Also, if no email account is found to be associated with the recipient 114 and stored in the database server 104, the messaging module 202 may automatically create an email account for the recipient 114 and store in the database server 104. The email messaging module 202 is preferably implemented using SMTP, LMTP or other similar server protocols. The email messages to and from the users 110, 114 is stored in email store 208.

The SMS gateway 204 is implemented using Hypertext Preprocessor (PHP) APIs. The Short Message Service (SMS) messages sent by the server 102 to the user communication device 108 of the user 110 using the SMS server/gateway 204.

The phone number to a predefined text email address conversion module 206 coverts the data (that's cell phone number) inputted by the user 110 into a predefined text email format address that includes the cell phone number of the user 110 and the domain name of the passwordless email serve website hosted on the server 102. The generated predefined text email address may be in the following forms: <cell phone number>@<domain name> or <country code><cell phone number>@<domain name>. Assuming, the user 110 inputs his cell phone number as 1245214589 then the predefined text email address to which the phone number gets converted would be: 1245214589@passwordlessemailservice.com or 245214589@ passwordlessemailservice.com

The event and task module 210 configured to facilitate the user 110 to create and assign one or more tasks to the other user 114, and create and share one or more calendar events with the other user 114. Particularly, the user 110 can create any calendar event and invite other user 114. Once the invite is sent, the other user 114 can either accept or reject the invitation for the event. Likewise, the user 110 can create and assign the task to the other user 114 and can also receive the tasks from the other users 114. The user 114 can either accept or reject the assigned task.

Referring to FIG. 3, a general block diagram for a system architecture of a computer system implemented as the passwordless e-mail service providing server that facilitates a passwordless e-mail communication between users is shown.

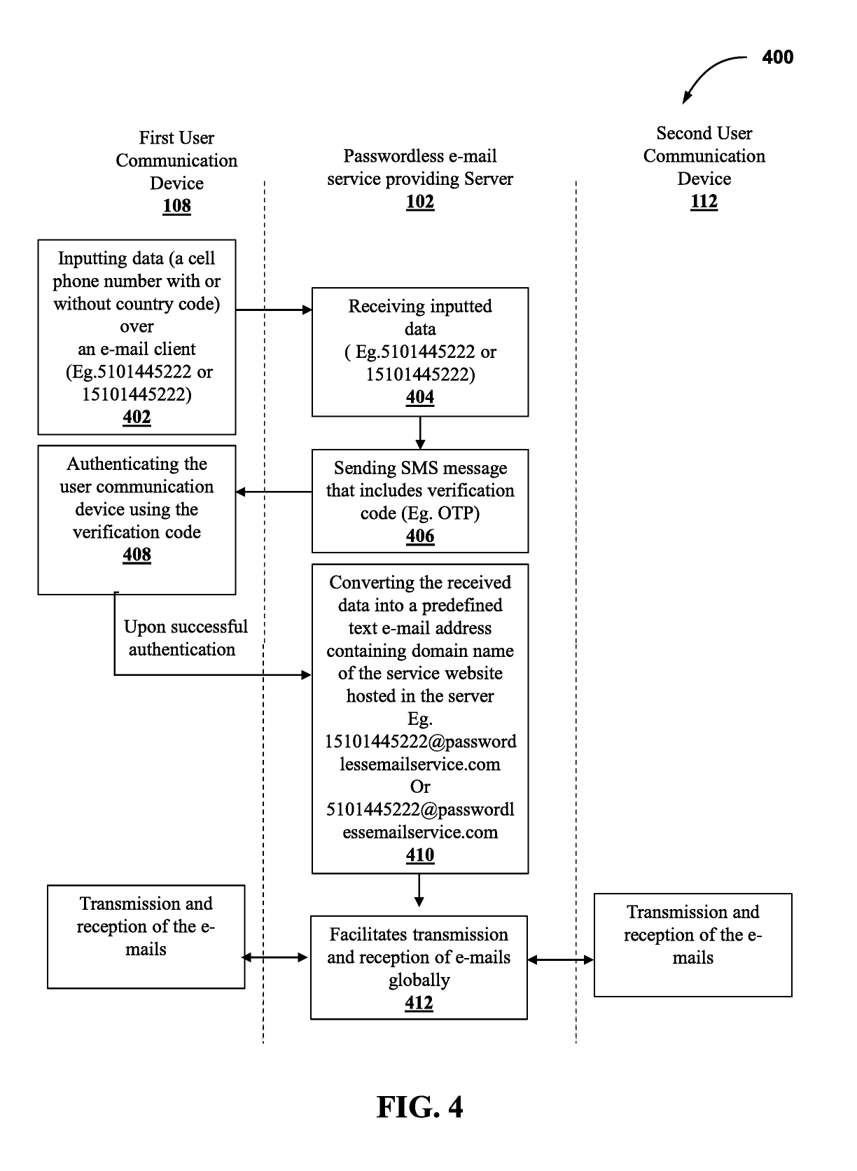

An embodiment of the present invention, or portions thereof, may be implemented as computer readable code on the computer system 200. As described above, the passwordless e-mail service providing server 102 of the FIG. 1 may be implemented in the computer system 200. Likewise, the user communication devices 108, 112 associated with the users 110,112 may be implemented using the computer system 200 or a portion of the system 200. Such implementation may use hardware, software, firmware, non-transitory computer readable media having instructions stored thereon, or a combination thereof and may be implemented in one or more computer systems or other processing systems. Hardware, software, or any combination thereof may embody modules and components used to implement the method described in the FIGS. 4-13. As seen in the FIG. 3, the computer system/server 102 includes a processor 302 that may be a special purpose or a general-purpose processing device. The processor 302 may be a single processor, multiple processors, or combinations thereof. Further, the processor 302 may be connected to a communication infrastructure 304, such as a bus, a bridge, a message queue, the network 106, multi-core message-passing scheme, and the like. The computer system/server 102 further includes a main memory 306 and a secondary memory 308. Examples of the main memory 306 may include RAM, ROM, and the like. The secondary memory 308 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system/server 102 further includes an input/output (I/O) port 310 and a communication interface 312. The I/O port 310 includes various input and output devices that are configured to communicate with the processor 302. The communication interface 312 may be configured to allow data to be transferred between the computer system/server 102 and various devices that are communicatively coupled to the computer system 102. Examples of the communication interface 312 may include a modem, a network interface, i.e., an Ethernet card, a communications port, and the like. Data transferred via the communication interface 312 may be signals, such as electronic, electromagnetic, optical, or other signals as will be apparent to a person skilled in the art. The signals may travel via a communications channel, such as the network 106, which may be configured to transmit the signals to the various devices that are communicatively coupled to the computer system/server 102. Computer program medium and computer usable medium may refer to memories, such as the main memory 306 and the secondary memory 308, which may be a semiconductor memory such as dynamic RAMs. These computer program mediums may provide data that enables the computer system/server 102 to implement the method illustrated in the FIGS. 4-13. In an embodiment, the present invention is implemented using a computer implemented application. The computer implemented application may be stored in a computer program product and loaded into the computer system/server 102 using the removable storage drive or the hard disk drive in the secondary memory 308, the I/O port 310, or the communication interface 312.

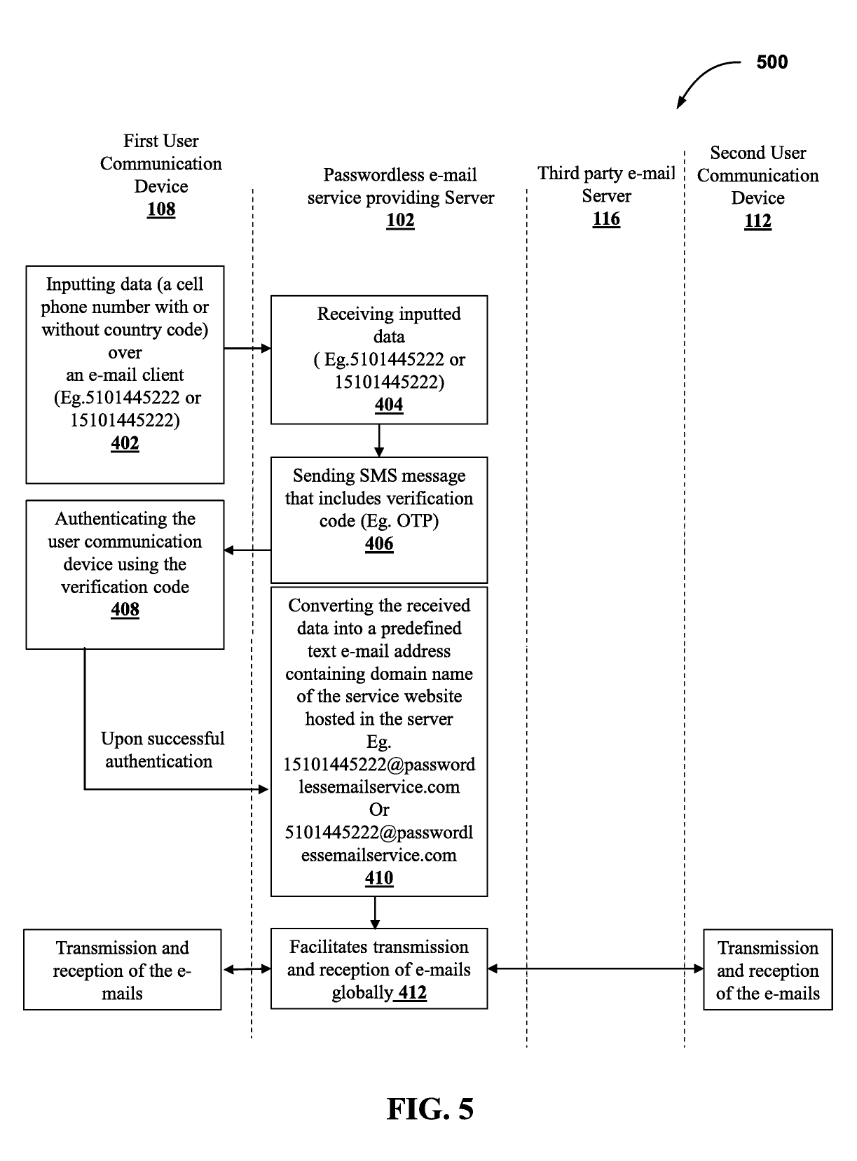

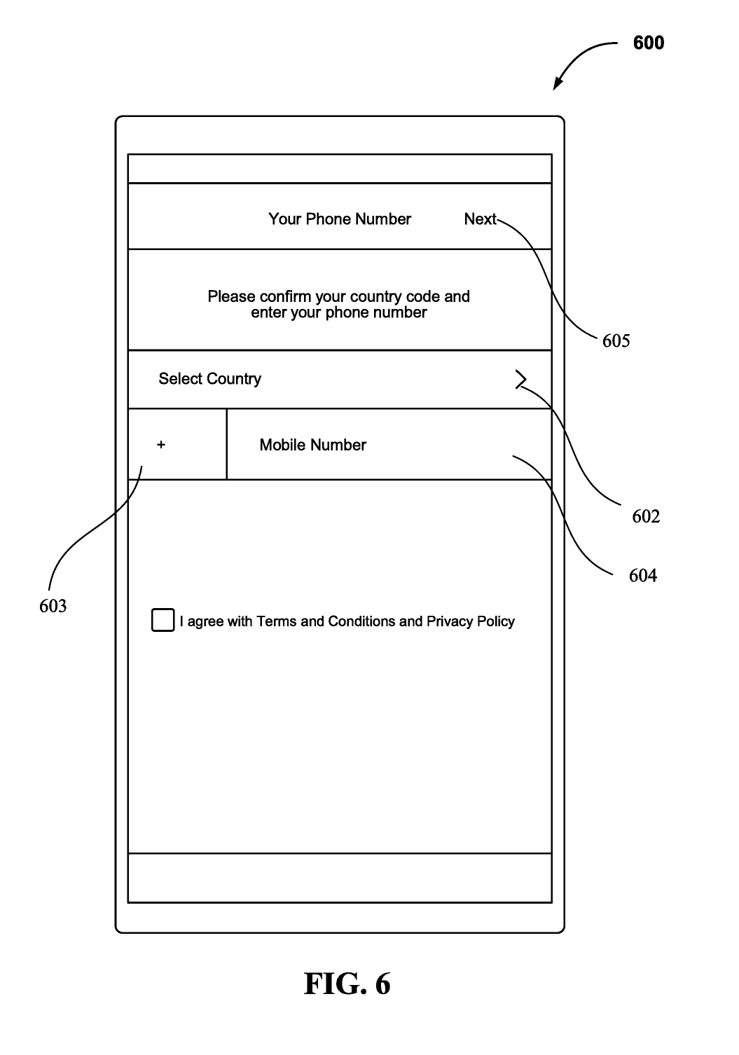

Referring to the FIGS. 4-5 in conjunction with the FIGS. 6-10, a method for the passwordless e-mail communication between the users is shown.

As seen in the FIGS. 4-5, at step 402, the user/sender 110 inputs data over the email client installed on the user communication device 108 associated with the user 110 for registering with the server 102 hosting the passwordless email service website with the domain name such as for example, “passwordlessemailservice.com”. The data that's inputted by the user 110 includes a cell phone number. The data may also include a country code associated with the cell phone number of the user 110. Referring specifically to the FIG. 6 that shows an example user interface 600 displayed to the user 110 over the email client installed on the user communication device 108 and enables the user 110 to fill in the data. The user 110 can select user's country by using a drop down list 602 that automatically fills in a country code box 603, then user 110 can fill in the user's cell phone number in a box 604 and move onto next step 605. Let's assume the user's country selected by the user 110 is United States, which has country code as +1, and the cell phone number entered by the user 110 to be 5101445222.

At steps 404, the server 102 receives the inputted data, particularly data includes 5101445222 and/or 15101445222. Besides receiving the inputted data, according to an embodiment, the server 102 automatically captures and stores (in the server database 104) an identity of the user communication device 108 associated with the user 110. The identity preferably includes but not limited to an International Mobile Equipment Identity (IMEI) number, and a mobile equipment identifier (MEID) number of the user communication device 108. The identity of the user communication device 108 of the user 110 enables the server 102 to automatically verify the user's registration status with it, thereby facilitating the user 110 to auto login on the e-mail client installed on the user communication device 108 without requiring the user 110 to remember any login credentials such as username and password. The identity of the user communication device 108 is captured and stored before sending the SMS message with the verification code to the user 110 as shown in step 406.

Upon receiving the inputted data along with the identity of the device 108 as described above, at the step 406, the server 102 then sends a Short Message Service (SMS) message using the SMS gateway 204 facilitated by PHP APIs. The SMS message includes a verification code to be used by the user 110 to authenticate the user communication device 108. The verification code may include but not limited to a one-time password, a PIN code, and a CAPTCHA.

Following the step 406, at step 408, the authentication of the user communication device 108 using the received verification code takes place. The authentication of the user communication device 108 with the verification code further necessitates the server 102 to receive the verification code inputted by the user 110 on the user communication device 108, compare the received verification code with the verification code sent to the user communication device 108 of the user 110, and finally, authenticate the user communication device 108 of the user 110 if the verification code inputted on the user communication device 108 by the user 110 matches the verification code sent to the user 110.

Following the step 408, upon successful authentication of the user communication device 108, the method proceeds to step 410. The step 410 describes conversion of the received data into a predefined text e-mail address containing the domain name of the service website hosted on the server 102. Considering the example presented at the steps 402, and 404, at the step 410, the module 206 of the server 102 converts the received data (5101445222 and/or 15101445222) into predefined text e-mail address of following formats: 15101445222@passwordlessemailservice.com Or 5101445222 @passwordlessemailservice.com.

Although the example shows the domain name in the format “.com”, it should be understood that scope of the present invention is not limited to any specific domain format thus any other domains such as for example “.net”, “.co.in” and so on may be used depending on what domain is owned by the email service provider or related to the service provider's website. Once the inputted data is converted to the predefined text email address format, the generated or converted predefined text email address is then stored in the server database 104 by the server 102 for future use and operations.

At step 412, upon conversion of the inputted data to the predefined text email address associated with the user 110, a user account related to the user 110 is created and stored in the database server 104. The server 102 then facilitates the user 110 to send and receive email messages globally to and from any other users 114 using the predefined text email address associated with the user 110. The transmission and reception of the e-mails globally using the predefined text email addresses of the users is facilitated by the email messaging module 202 discussed above.

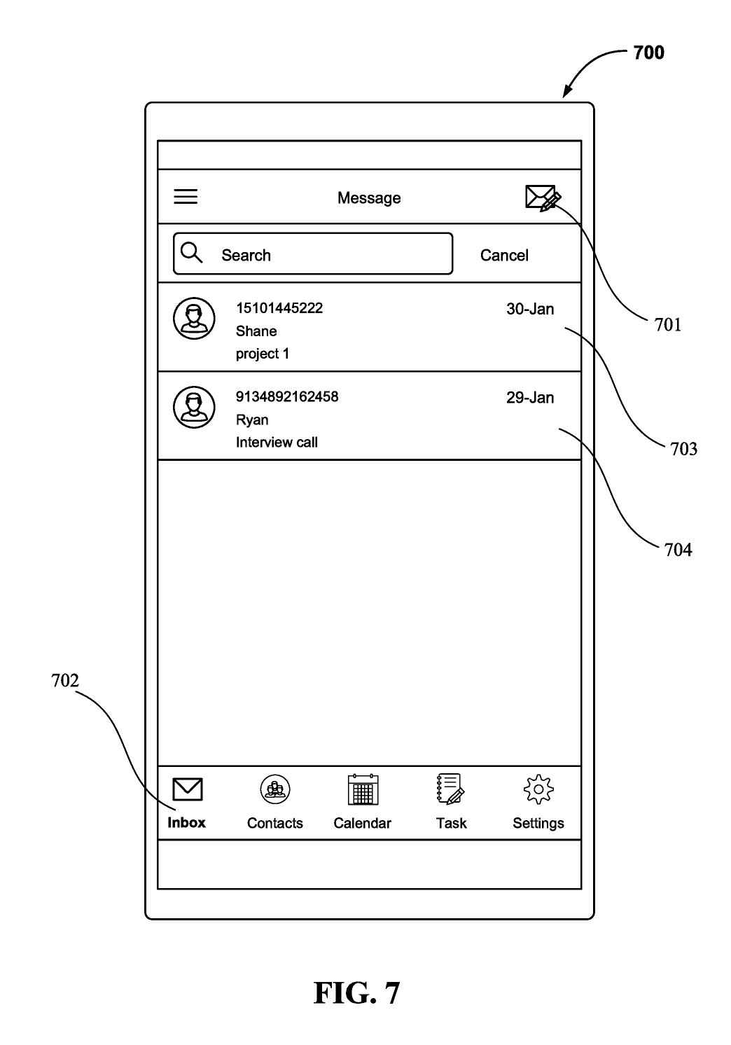

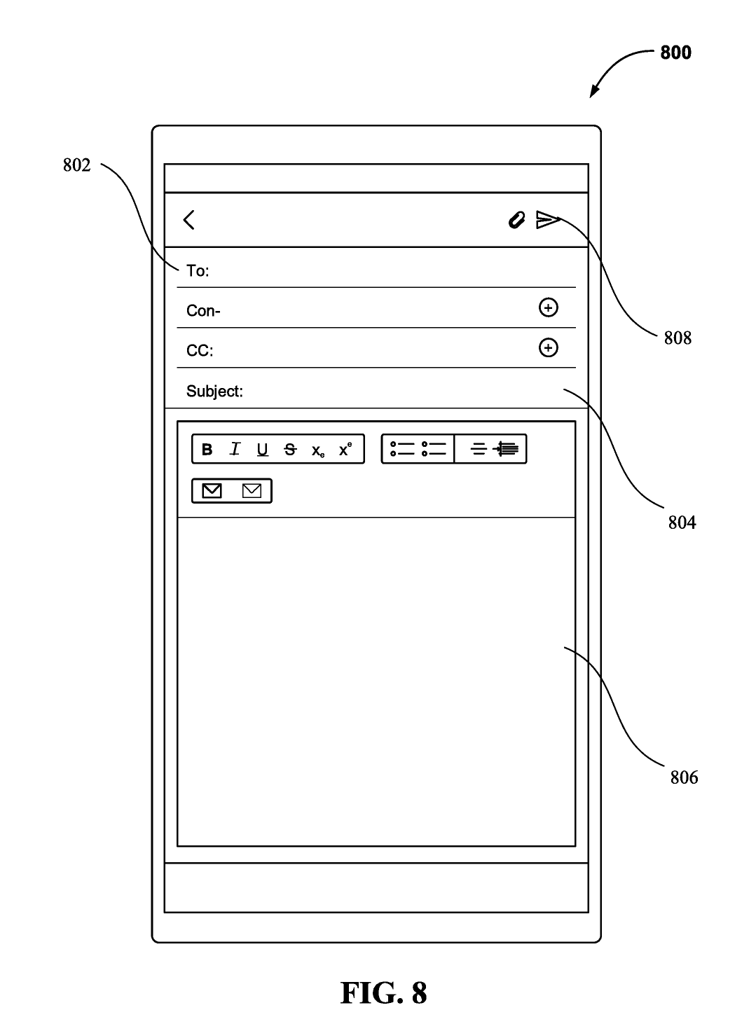

As shown in the FIGS. 1 and 4, the user/sender 110 may send and receive the email messages globally to and from the user/recipient 114 who may also be registered with the server 102. Referring specifically to the FIG. 7 and FIG. 8, that shows example user interfaces 700 and 800 displayed to the user 110 over the email client installed on the user communication device 108 for enabling the user 110 to view incoming messages, compose and address the new email message to be sent to other user 114 registered with the server 102. As shown in the FIG. 7, the inbox 702 shows the two email messages 703, 704 received by the user 110 from the two other users 114, namely Shane, and Ryan. As seen, the inbox messages 703, 704 received by the user 110 from the other users 114 include the name of senders/users 114, the cell phone number associated with those users 114, and subject line of the email messages. In an example, if the sender/users 114 are not registered users of the server 102, then the user 110 will be shown the actual third party email addresses associated with the users 114 instead of their cell phone numbers.

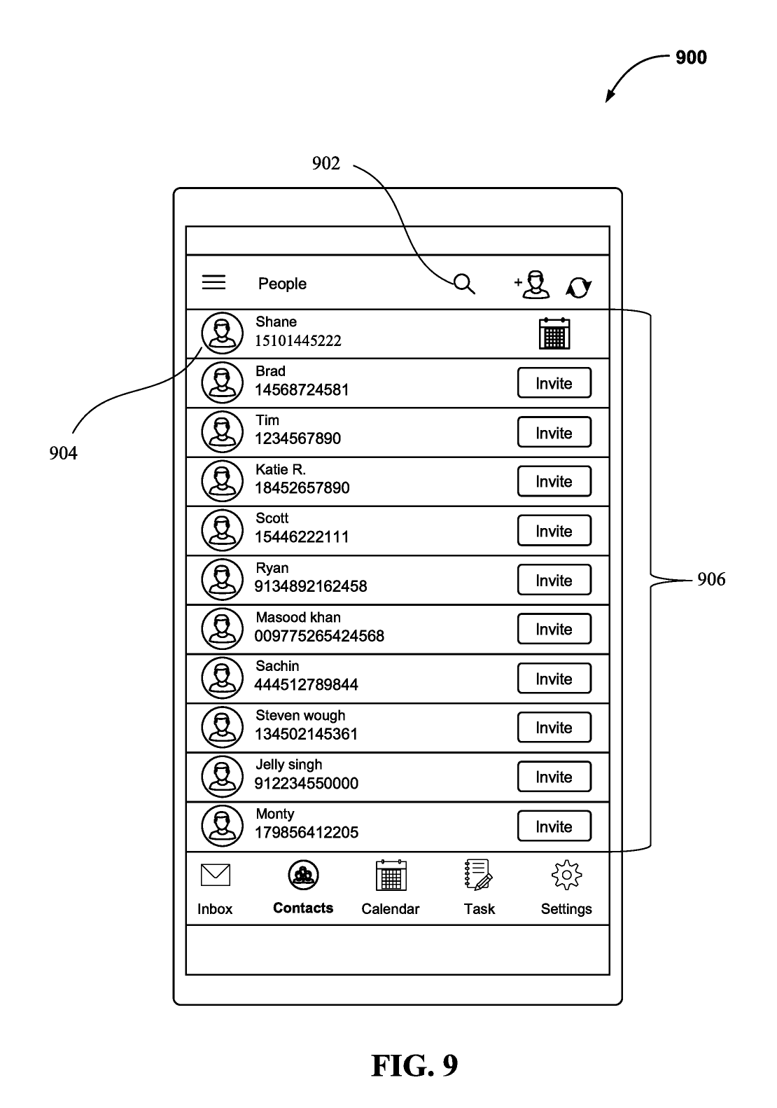

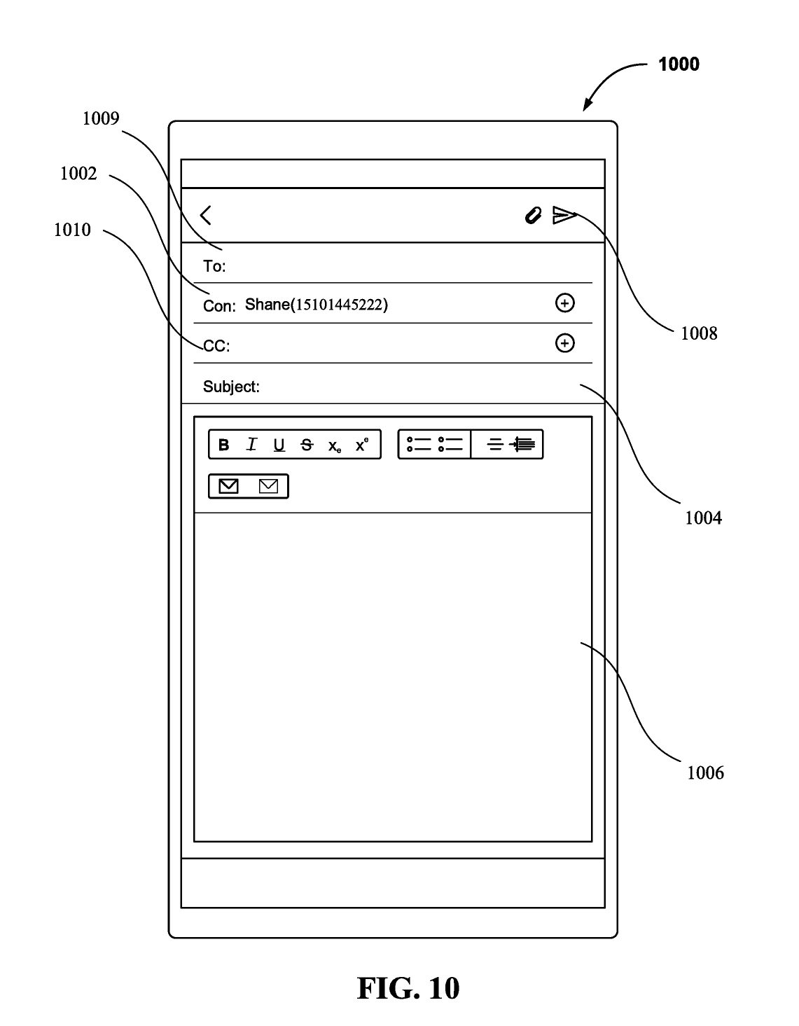

As seen in the FIGS. 7 and 8, the user 110 can click on the compose message icon 701 and then draft the email message and address the email message to the other user 114. As shown in the FIG. 8, the user 110 can enter the cell phone number (or if known then the predefined text email address) of the other user/recipient 114 at address bar 802. Then the user 110 can provide a subject 804 for the email message, draft the email body 806 and send 808 the email message to the other user 114. In an example, as shown in the FIGS. 9-10, if the other user/recipient 114 is already known to the user 110 and present as a contact 904 in his/her phonebook 906 and both the users 110, 114 are registered with the server 102, then the user 110 can just select (or search and select 902) the contact 904 of the other user 114 from a plurality of contacts present in the phonebook 906 of the user communication device 108 to send and receive emails globally to and from the other user 114 without needing to enter the predefined text email address or the cell phone number associated with the contact 904. In the example shown, assuming Shane with phone number 15101445222 and the user 110 are both registered users of the server 102 and Shane is already present in as the contact 904 in the phonebook 906 of the user 110 in the user communication device 108, then the user 110 can click on the search icon 902 and search for Shane and can just tap on the name or contact information 904 then the user interface 1000 as shown in the FIG. 10 will appear, where Shane will be auto selected and addressed in Con.: address bar 1002 without requiring the user 110 to key in the cell phone number or the predefined text email address associated with Shane. The user 110 can then provide a subject 1004 for the email message to be sent to Shane, draft the email body 1006 and send 1008 to Shane. According to the embodiment, the user interface 1000 provided by the server 102 over the user communication device 108 may also allow the user 110 to reply to emails, cc the email to multiple users in one go, forward the emails to the other users or the like known in the art.

According to other embodiment, the user 110 can also use the UIs 800 or 1000 to send emails (fresh emails or ccs) to other users 114 who are not registered with the server 102 and may or may not be in the user 110 related phonebook 906. For example, the user 110 can send emails to other users 114 who are users of various other email servers (third-party email servers 116) or email service providers such as Gmail, Yahoo, Hotmail, AOL or other business related email servers etc. The user 110 can use at least one email address belonging to such users 114 and then address the email message using that third party provided email address to send to the user 114. For example, assuming the other user/recipient 114 to have a Gmail address as user@gmail.com, then the user/sender 110 can use this third party provided email address associated with the user 114 to send the email message. The user 110 can address the email message using to: address bars 1009 and/or cc: address bar 1010 to send the email message to the other user 114. Whenever, there is transmission and reception of the email messages between the user 110 and the other users 114 of the other email services, it necessitates the server 102 to communicate with the third party server 116 as well in order to route the incoming email messages to and from the user 110 and the other users 114. The email messaging module 202 of the server 102 receives the email messages from the user/sender 110 and direct the email to the user/recipient 114 and vice versa. During such email messages routing to and from the users 110, 114, the email messages are stored in the email store 208. The server 102 also notifies the other users 114 of other third party email services about new e-mails, and prompts the users 114 to install the e-mail client on the user communication devices associated therewith, in response to detecting the users 114 are unregistered with the server 102.

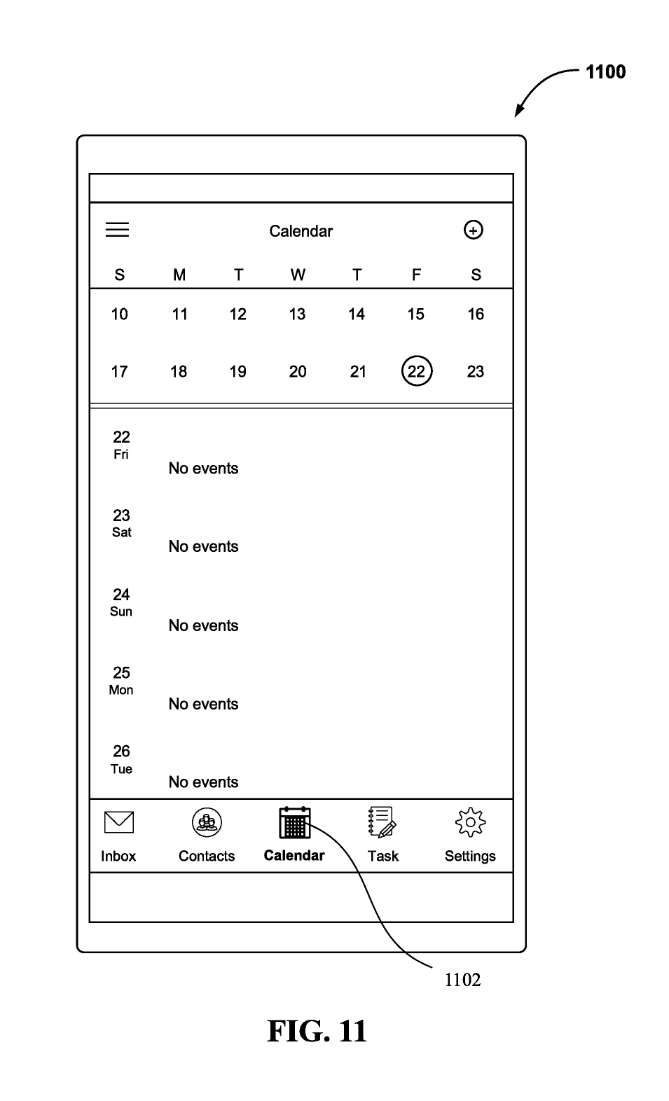

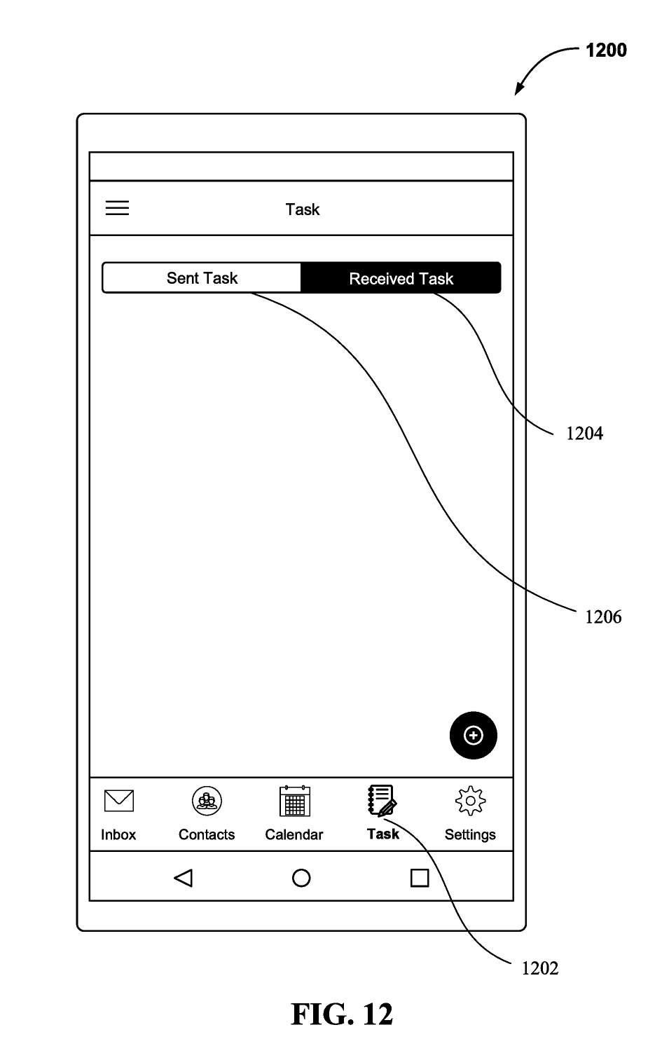

Referring to the FIGS. 11-12, example user interfaces 1100 and 1200 for the event and task module 210 is shown. The user interface 1100 facilitates the user 110 to view and update a calendar 1102 associated therewith. The user 110 can create any calendar event by selecting specific date from the calendar 1102 and invite other user 114 for the event. Once the invite is sent, the other user 114 can either accept or reject the invitation. If the other user 114 is in the user's 110 contact list then user 110 can easily view the user's 114 calendar to see possible engagement of the user 114 during the day or user's engagement for upcoming days. Further, the user interface 1200 facilitates the user 110 with a tab 1202 to create and assign one or more tasks to the other user 114. The user 114 can either accept or reject the assigned task. The user 110 can view the task he/she has assigned/sent 1206 to other users 114 and even can view the tasks the user 110 received 1204 from the other user 114. According to the embodiment, the user 110 is also enabled to update the status of the tasks he/she is working on, such as the user 110 can mark the task as completed, or mark the task as in-progress and so on.

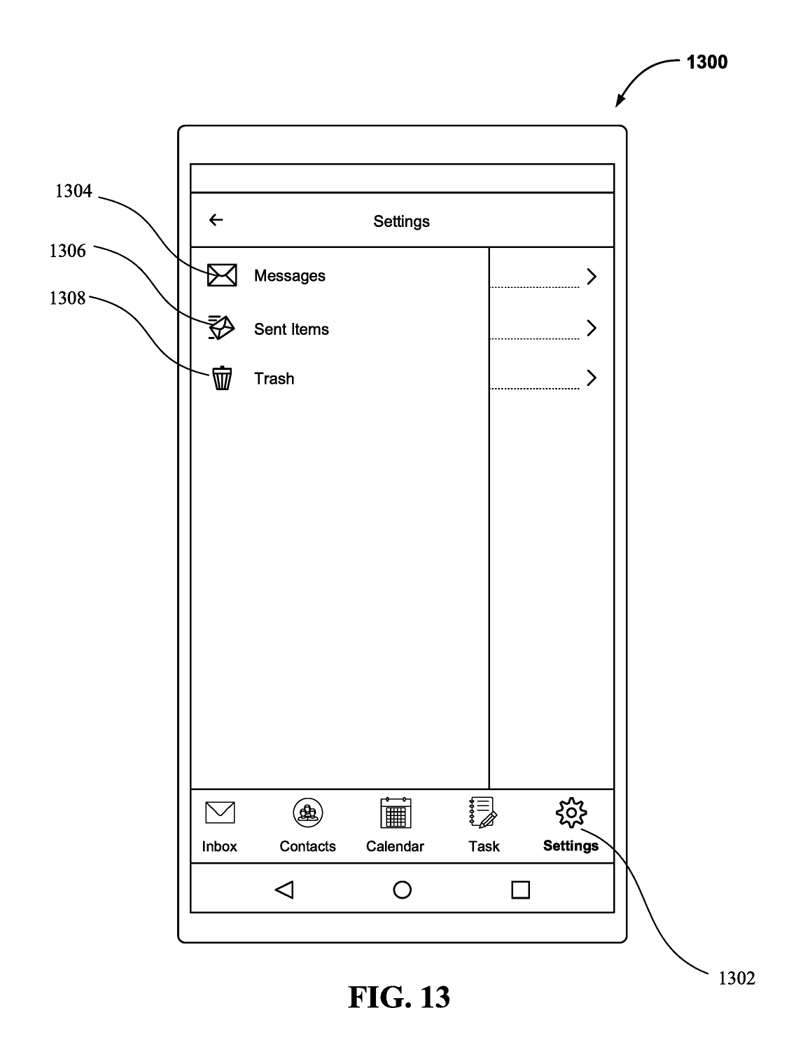

Referring to the FIG. 13, an example user interface 1300 is shown. Using the user interface 1300, particularly a tab 1302, the user 110 can edit his/her profile related information, can check for any event and tasks update that the user 110 has assigned to or shared with other users 114. Further as seen in the FIG. 13, the user 110 is also provided with options to view sent email messages 1306, view deleted email messages 1308 and check the incoming email messages 1304.

The preceding description has been presented with reference to various embodiments. Persons skilled in the art and technology to which this application pertains will appreciate that alterations and changes in the described structures and methods of operation can be practiced without meaningfully departing from the principle, spirit and scope of the present invention.

What is claimed is:

1. A passwordless electronic mail (e-mail) communication method, comprising:
receiving data inputted over an e-mail client installed on a user communication device of a first user for registering the first user with a first server hosting a passwordless email service website with a domain name, wherein the data for registering the user communication device of the first user with the first server comprising at least one of: a cell phone number, and a country code;
sending, by the first server, a Short Message Service (SMS) message comprising a verification code to the user communication device of the first user using Hypertext Preprocessor (PHP) APIs;
authenticating, by the first user, the user communication device using the received verification code; and,
in response to a successful authentication of the user communication device of the first user: converting, by the first server, at least one of: the cell phone number, and the country code of the first user into a predefined text email address comprising the cell phone number and the domain name, and facilitating the first user with transmission and reception of e-mails globally, to and from a second user using the predefined text email address.

2. The method of claim 1, wherein the predefined text email address is in format: <cell phone number>@<domain name>.

3. The method of claim 1, wherein the predefined text email address is in the format: <country code><cell phone number>@<domain name>.

4. The method of claim 1, wherein the verification code sent to the user communication device of the first user comprises at least one of a one-time password, a PIN code, and a CAPTCHA.

5. The method of claim 1 further comprising automatically capturing and storing, by the first server an identity of the user communication device of the first user, wherein the identity of the user communication device is captured before sending the SMS message with the verification code to the first user.

6. The method of claim 5, wherein the identity comprises at least one of an International Mobile Equipment Identity (IMEI) number, and a mobile equipment identifier (MEID) number of the user communication device.

7. The method of claim 5, wherein the identity of the user communication device of the first user captured and stored by the first server enables the first server to auto verify the first user's registration status with the first server, thereby facilitating the first user to auto login on the e-mail client installed on the user communication device associated therewith.

8. The method of claim 1, wherein the transmission and reception of the e-mails globally to and from the second user by the first user using the predefined text email address is facilitated via the first server, if the second user is found to be registered with the first server.

9. The method of claim 1, wherein the transmission and reception of the e-mails globally to and from the second user by the first user using the predefined text email address is facilitated via the first server and a second server, if the second user is found to be unregistered with the first server.

10. The method of claim 9, wherein the second server comprising a third-party email server.

11. The method of claim 9 further comprising notifying the second user about new e-mails, and prompting the second user to install the e-mail client on a user communication device of the second user, in response to detecting the second user is unregistered with the first server.

12. The method of claim 1 further comprising
creating and assigning one or more tasks to the second user by the first user, and
creating and sharing one or more calendar events with the second user by the first user.

13. The method of claim 1 further comprising
enabling, the first user to select a first contact from a plurality of contacts present in a phonebook of the user communication device associated therewith to send and receive emails globally to and from the selected first contact without needing to enter the predefined text email address associated with the first contact, if the selected first contact is already registered with the first server, and
providing, a user interface in response to the selection of the first contact, wherein the user interface facilitates the first user to compose a new e-mail, reply to an email, forward the email to the first contact.

14. The method of claim 1 further comprising
enabling, the first user to select a second contact from the plurality of contacts present in the phonebook of the user communication device associated therewith to send and receive emails globally to and from the selected second contact by utilizing a third party email address owned by the selected second contact, if the selected second contact is unregistered with the first server, and
providing, the user interface in response to the selection of the second contact, wherein the user interface facilitates the first user to compose a new e-mail, reply to an email, forward the email to the second contact, address the e-mail for transmission to the second contact.

15. The method of claim 1, wherein the authentication of the user communication device of the first user with the verification code further comprising:
receiving the verification code inputted on the e-mail client installed on the user communication device of the first user;
comparing the received verification code with the verification code sent to the user communication device of the first user; and
authenticating the user communication device of the first user if the verification code inputted on the user communication device by the first user matches the verification code sent to the first user.

16. A passwordless electronic mail (e-mail) communication system, comprising:
a first server hosting a passwordless email service website with a domain name, a user communication device of a first user with an e-mail client installed thereon, wherein the first server configured to:
receive data inputted over the e-mail client installed on the user communication device of the first user for registering the first user with the first server, wherein the data for registering the user communication device of the first user with the first server comprising at least one of: a cell phone number, and a country code;
send a Short Message Service (SMS) message comprising a verification code to the user communication device of the first user using Hypertext Preprocessor (PHP) APIs;
in response to receiving the verification code by the first user, authenticate the user communication device associated therewith; and
in response to a successful authentication of the user communication device of the first user: convert at least one of: the cell phone number, and the country code of the first user into a predefined text email address comprising the cell phone number and the domain name of the passwordless email service website, and facilitate the first user with transmission and reception of e-mails globally, to and from a second user using the predefined text email address.

17. The system of claim 16, wherein the verification code sent to the user communication device of the first user comprises at least one of a one-time password, a PIN code, and a CAPTCHA.

18. The system of claim 16, wherein the predefined text email address is in format <cell phone number>@<domain name>.

19. The method of claim 16, wherein the predefined text email address is in format <country code><cell phone number>@<domain name>.

20. The system of claim 16, wherein the first server further configured to automatically capture and store an identity of the user communication device of the first user, wherein the identity of the user communication device is captured before sending the SMS message with the verification code to the first user.

21. The system of claim 20, wherein the identity of the user communication device of the first user captured and stored by the first server enables the first server to auto verify the first user's registration with the first server, thereby facilitating the first user to auto login on the e-mail client installed on the user communication device associated therewith.

22. The system of claim 16, wherein the first server further configured to facilitate:
transmission and reception of the e-mails globally to and from the second user by the first user using the predefined text email address, if the second user is found to be registered with the first server;
transmission and reception of the e-mails globally to and from the second user by the first user using the predefined text email address via a second server, if the second user is found to be unregistered with the first server;
notifying the second user about new e-mails, and prompting the second user to install the e-mail client on a user communication device of the second user, in response to detecting the second user is unregistered with the first server;
enabling the first user to create and assign one or more tasks to the second user; and
enabling the first user to create and sharing one or more calendar events with the second user.

23. The system of claim 22, wherein the second server comprising a third-party email server.
